(19) United States
(12) Patent Application Publication
(10) Pub. No.: US 2024/0096054 A1
(43) Pub. Date: Mar. 21, 2024

(54) DETECTION SYSTEM, DETECTION METHOD, PROGRAM, AND DETECTION MODULE

(71) Applicant: NIPPON CHEMI-CON CORPORATION, Tokyo (JP)

(72) Inventors: Ryo Sato, Tokyo (JP); Katsuya Tamaki, Tokyo (JP); Naohisa Shibata, Tokyo (JP)

(73) Assignee: NIPPON CHEMI-CON CORPORATION, Tokyo (JP)

(21) Appl. No.: 18/244,522

(22) Filed: Sep. 11, 2023

(30) Foreign Application Priority Data
Sep. 21, 2022 (JP) 2022-149734

(51) Int. Cl. G06V 10/74; G06T 7/11; G06T 7/62

(52) U.S. Cl. CPC G06V 10/761; G06T 7/11; G06T 7/62

(57) ABSTRACT

A detection system includes an imaging unit configured to acquire a distance image indicating a distance to a target object, and a processing unit configured to divide pixels included in the distance image into blocks according to a distance relationship, and detects a state of the target object by comparing ratios of pixels included in the respective blocks.

### CROSS-REFERENCE TO RELATED APPLICATIONS

This application is entitled to the benefit of priority of Japanese Patent Application No. 2022-149734, filed on Sep. 21, 2022 the contents of which are hereby incorporated by reference.

### BACKGROUND OF THE INVENTION

### i) Field of the Invention

The present disclosure relates to, for example, a detection technique used for detecting a state of an object such as a person.

### ii) Description of the Related Art

A Time-of-Flight Camera (ToF camera) is a camera capable of irradiating a target object with light and measuring three-dimensional information (distance image) from the target object using an arrival time of reflected light.

Regarding the detection technique by the ToF camera, it is known that a difference image is acquired from a captured image by background difference processing, a head is estimated from a human object included in the difference image, a distance between the head and a floor surface of a target space is calculated to determine a human posture, and a human behavior is detected from the posture and position information of the object (for example, JP 2015-130014 A).

Regarding abnormality detection of a target object, it is known to measure a time indicating a stationary state of the target object and to determine that there is an abnormality when the time exceeds a threshold (for example, JP 2008-052631 A).

Regarding abnormality monitoring, it is known to monitor a temporal change in a distance of a measurement point in an arbitrary region in a distance image and to recognize an abnormality when the temporal change exceeds a certain range (for example, JP 2019-124659 A).

Regarding detection of a moving object, it is known that a movement vector and a volume of an object in a detection space are calculated from a distance image, and a detection target is detected on the basis of the movement vector and the volume (for example, JP 2022-051172 A).

### BRIEF SUMMARY OF THE INVENTION

In a case where a target object whose state such as behavior is to be detected is, for example, a human, there is a problem to be prioritized over acquisition of state information such as abnormality detection, such as attribute information such as a portrait and information regarding privacy. In imaging by a general camera, even when abnormality can be detected, personal information such as privacy cannot be protected.

Meanwhile, according to a distance image obtained by a ToF camera, even when the target object is a human, it is possible to prevent exposure of the privacy and personal information. However, the distance image is three-dimensional information including range information and distance information of the target object, and it is not easy to detect the state on the target object from the three-dimensional information.

The inventors of the present disclosure have found that when a pixel is selected at a specific distance from the distance image indicating a distance between a target object and a sensor, a state such as an abnormality of the target object can be detected using the selected image.

An object of the present disclosure is to detect a state such as an abnormality of a target object by a virtual area or a virtual volume calculated by a pixel selected at a specific distance from the distance image.

According to an aspect of a detection system of the present disclosure, there is provided a detection system including: an imaging unit configured to acquire a distance image indicating a distance to a target object; and a processing unit configured to divide pixels included in the distance image into blocks according to a distance relationship, and detect a state of the target object by comparing ratios of pixels included in the respective blocks.

According to an aspect of a detection method of the present disclosure, there is provided a detection method including: acquiring, by an imaging unit, a distance image in time sequence, the distance image indicating a distance to a target object; detecting, by the processing unit, a state of the target object by dividing pixels included in the distance image into blocks according to a distance relationship and comparing a ratio of pixels included in the respective blocks; and calculating a virtual area or a virtual volume for each block for at least each state of the target object by using the pixels included in the respective blocks.

According to an aspect of a program of the present disclosure, there is provided a program for causing a computer to execute: acquiring a distance image indicating a distance to a target object in time sequence; and dividing pixels included in the distance image into blocks according to a difference relationship and detecting a state of the target object by comparing ratios of pixels included in the respective blocks.

According to an aspect of a detection module of the present disclosure, there is provided a detection module including: an imaging unit configured to acquire a distance image indicating a distance to a target object in time sequence; and a processing unit configured to divide pixels included in the distance image into blocks according to a distance relationship, and detect a state of the target object by comparing ratios of pixels included in the respective blocks.

### BRIEF DESCRIPTION OF THE SEVERAL VIEWS OF THE DRAWING

FIG. 1 is a diagram illustrating a detection system according to a first embodiment.

FIG. 2 is a diagram illustrating an example of a detection information database according to the first embodiment.

FIG. 3 is a flowchart illustrating a processing procedure of state detection according to the first embodiment.

FIG. 4A is a diagram illustrating a state A of a target object, FIG. 4B is a diagram illustrating a state B, and FIG. 4C is a diagram illustrating a state C.

FIG. 5A is a diagram illustrating a distance image of the state B (FIG. 4B) of the target object, and FIG. 5B is a diagram illustrating a virtual area image.

FIG. 6A is a diagram illustrating a virtual area image of a first block (FIG. 5B), FIG. 6B is a diagram illustrating a virtual area image of a second block (FIG. 5B), and FIG. 6C is a diagram illustrating a virtual area image of a third block (FIG. 5B).

FIG. 7A is a diagram illustrating a distance image of the state C (FIG. 4C) of the target object, and FIG. 7B is a diagram illustrating a virtual area image.

FIG. 8A is a diagram illustrating a virtual area image of a first block (FIG. 7B), FIG. 8B is a diagram illustrating a virtual area image of a second block (FIG. 7B), and FIG. 8C is a diagram illustrating a virtual area image of a third block (FIG. 7B).

FIG. 9 is a diagram illustrating an example of a detection information database according to a second embodiment.

FIG. 10 is a flowchart illustrating a processing procedure of a detection system according to the second embodiment.

FIG. 11A is a diagram illustrating a distance image of a state B (FIG. 4B) of the target object, and FIG. 11B is a diagram illustrating a first block and a virtual volume image.

FIG. 12A is a diagram illustrating a virtual volume image of a first block (FIG. 11B), FIG. 12B is a diagram illustrating a virtual volume image of a second block (FIG. 11B), and FIG. 12C is a diagram illustrating a virtual volume image of a third block (FIG. 11B).

FIG. 13A is a diagram illustrating a distance image of a state C (FIG. 4C) of the target object, and FIG. 13B is a diagram illustrating a virtual volume image.

FIG. 14A is a diagram illustrating a virtual volume image of a first block (FIG. 13B), FIG. 14B is a diagram illustrating a virtual volume image of a second block (FIG. 13B), and FIG. 14C is a diagram illustrating a virtual volume image of a third block (FIG. 13B).

FIG. 15 is a diagram illustrating a detection module according to an example.

### DETAILED DESCRIPTION OF THE INVENTION

### First Embodiment

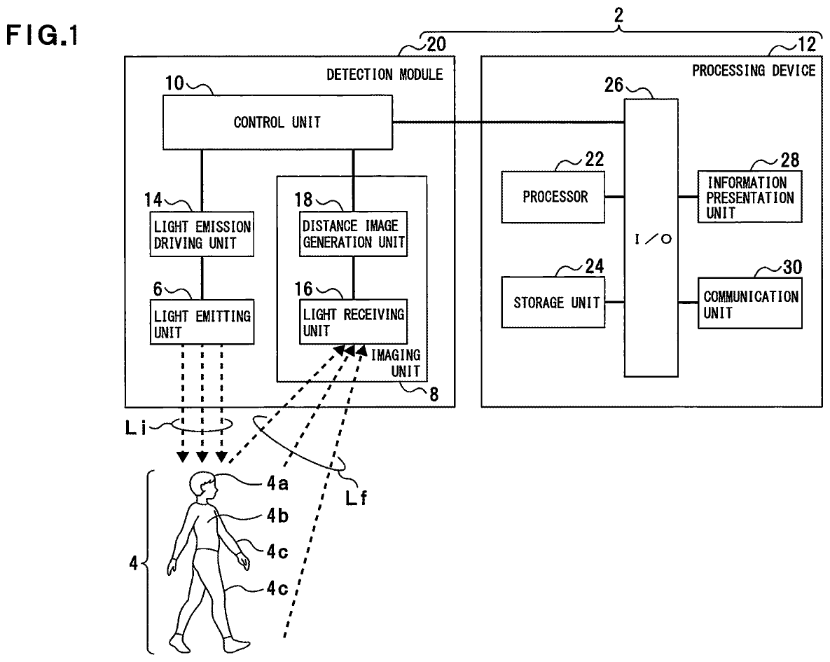

FIG. 1 is a diagram illustrating a detection system 2 according to a first embodiment. The configuration illustrated in FIG. 1 is an example, and the present disclosure is not limited to such a configuration.

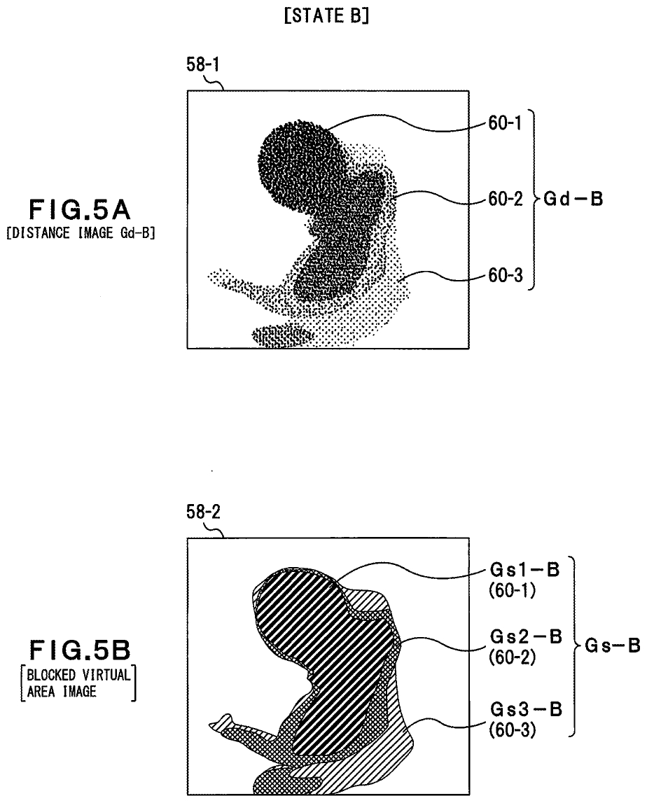

The detection system 2 is a system that detects a state of a target object 4 using a distance image Gd acquired from the target object 4. The target object 4 is a moving body or the like, and when the target object 4 whose state is to be detected is, for example, a human, behavior information indicating movement of a head 4a, a body 4b, a limb 4c, and the like is displayed in the distance image Gd (FIG. 5 or the like).

The detection system 2 illustrated in FIG. 1 includes a light emitting unit 6, an imaging unit 8, a control unit 10, a processing device 12, and the like. The light emitting unit 6 receives a drive output from a light emission driving unit 14 under the control of the control unit 10 to cause intermittent light emission, and irradiates the target object 4 with light Li. Reflected light Lf is obtained from the target object 4 that has received the light Li. The time from the time point of emission of the light Li to the time point of reception of the reflected light Lf indicates a distance.

The imaging unit 8 is an example of an imaging unit of the present disclosure, and includes a light receiving unit 16 and distance image generation unit 18. The light receiving unit 16 receives the reflected light Lf from the target object 4 in time sequence in synchronization with the light emission of the light emitting unit 6 under the control of the control unit 10, and outputs a light reception signal. The distance image generation unit 18 receives the light reception signal from the light receiving unit 16 and generates the distance images Gd in time sequence. Therefore, the imaging unit 8 acquires the distance images Gd indicating a distance between the target object 4 and the imaging unit 8 in time sequence in units of frames.

The control unit 10 includes, for example, a computer, and executes light emission control of the light emitting unit 6 and imaging control of the imaging unit 8 by executing an imaging program. The light emitting unit 6, the imaging unit 8, the control unit 10, and the light emission driving unit 14 are an example of a detection module 20 of the present disclosure, and can be configured by, for example, a one-package discrete element such as a one-chip IC. The detection module 20 constitutes an ToF camera.

The processing device 12 is an example of a processing unit of the present disclosure. In the present embodiment, the processing device 12 is, for example, a personal computer having a communication function, and includes a processor 22, a storage unit 24, an input/output unit (I/O) 26, an information presentation unit 28, a communication unit 30, and the like.

The processor 22 executes an operating system (OS) in the storage unit 24 and the detection program of the present disclosure, and executes information processing necessary for state detection of the target object 4.

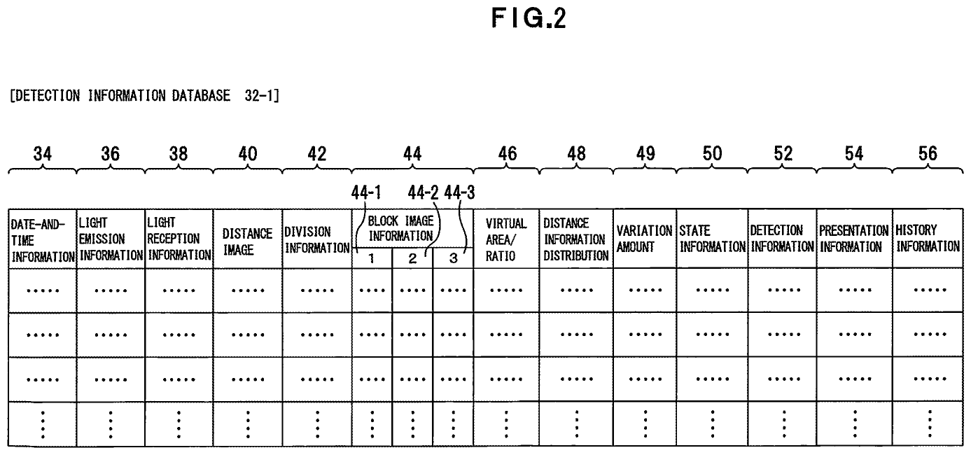

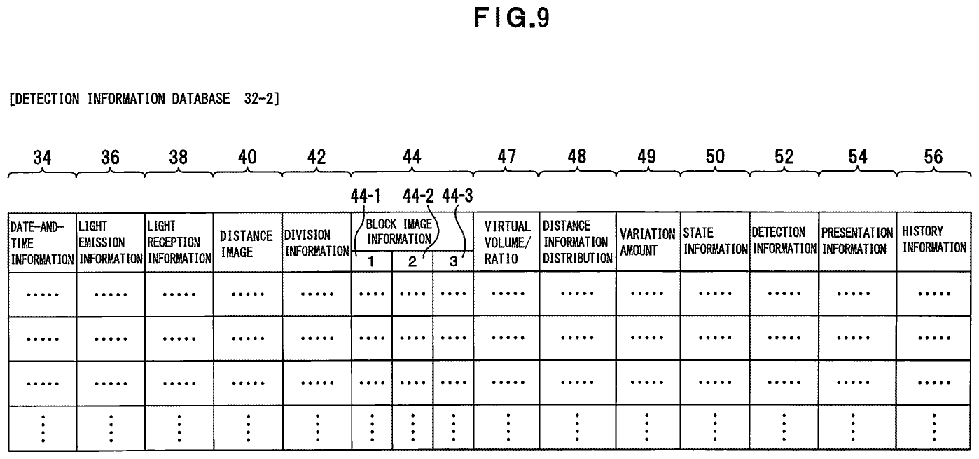

The storage unit 24 stores the OS, the detection program, detection information databases 32-1 (FIG. 2) and 32-2 (FIG. 9) used for information processing necessary for state detection, and the like. The storage unit 24 includes storage elements such as a read-only memory (ROM) and a random-access memory (RAM). The input/output unit 26 inputs and outputs information under the control of the processor 22.

In addition to the information presentation unit 28, an operation input unit (not illustrated) is connected to the input/output unit 26. The input/output unit 26 receives operation input information by a user operation or the like, and obtains output information based on information processing of the processor 22.

The information presentation unit 28 is an example of an information presentation unit of the present disclosure, and includes, for example, a liquid crystal display (LCD). Under the control of the processor 22, the information presentation unit 28 presents image information Dg including any or two or more of the distance image Gd, a virtual area Vs to be described later, and state information Sx indicating the state of the target object 4. As the operation input unit, for example, a touch panel installed on a screen of an LCD of the information presentation unit 28 may be used.

The communication unit 30 is connected to an information device such as a communication terminal (not illustrated) in a wired or wireless manner through a public line or the like under the control of the processor 22, and can present state information of the target object 4 and the like to the communication terminal.

### <Control by Control Unit 10>

The control by the control unit 10 includes processing such as a) light emission control of the light Li, b) light reception control of the reflected light Lf, c) generation processing of the distance image Gd, and d) transmission control of the distance image Gd.

### a) Light Emission Control of Light Li

The control unit 10 performs light emission control of the light emitting unit 6 in order to generate the reflected light Lf from the target object 4. In order to cause the light emitting unit 6 to intermittently emit light, a drive signal is provided from the light emission driving unit 14 to the light emitting unit 6 under the control of the control unit 10. As a result, the light emitting unit 6 emits intermittent light Li to irradiate the target object 4.

### b) Light Reception Control of Reflected Light Lf

In order to receive the reflected light Lf from the target object 4 that has received the light Li, the control unit 10 performs light reception control of the light receiving unit 16. As a result, the reflected light Lf from the target object 4 is received by the light receiving unit 16. By this light reception, a light reception signal is generated and provided from the light receiving unit 16 to the distance image generation unit 18.

### c) Generation Processing of Distance Image Gd

Under the control of the control unit 10, the distance image generation unit 18 generates the distance images Gd using the light reception signal. The distance image Gd includes pixels gi indicating different light receiving distances depending on unevenness and a distance of the target object 4.

### d) Transmission Control of Distance Image Gd

The control unit 10 receives the distance images Gd from the distance image generation unit 18 and transmits the distance images Gd to the processing device 12 in units of frames.

### <Information Processing by Processing Device 12>

The information processing of the processing device 12 includes processing such as e) acquisition of the distance image Gd, 0 division of the distance image Gd, g) generation of a virtual area image Gs, h) calculation of the virtual area for each block, i) calculation of the ratios of blocks, j) detection of variation in distance information distribution, k) presence and state detection of the target object 4, l) presentation of the distance image, the virtual area image, the state information, and the determination information, and m) generation and update of the detection information database 32-1.

### e) Acquisition of Distance Image Gd

The processing device 12 acquires the distance images Gd in time sequence under the control of the processor 22. The distance image Gd is executed in units of frames.

### f) Division of Distance Image Gd

Under the control of the processor 22, the processing device 12 divides a plurality of pixels gi included in the distance image Gd into two or more blocks according to a distance relationship, i.e. far and near relationship. This division is, for example, divided into a first block, a second block, and a third block.

### g) Generation of Virtual Area Image Gs

The processing device 12 generates the virtual area image Gs divided for each block from the distance image Gd divided into blocks under the control of the processor 22.

### h) Calculation of Virtual Area Vs for Each Block

The processing device 12 calculates virtual areas Vs1, Vs2, and Vs3 for each of the first block, the second block, and the third block for at least each state of the target object 4 using the pixels gi included in the first block, the second block, and the third block.

Assuming that g1 is the number of the pixels gi included in the first block, that g2 is the number of the pixels gi included in the second block, that g3 is the number of the pixels gi included in the third block, and that k is a conversion coefficient for converting the number of the pixels gi into an area, the virtual area Vs1 of the first block, the virtual area Vs2 of the second block, and the virtual area Vs3 of the third block can be expressed by Expressions 1, 2, and 3.

Vs1=kg1 (Expression 1)

Vs2=kg2 (Expression 2)

Vs3=kg3 (Expression 3)

### i) Calculation of Ratios R11, R12, R13 of Blocks

The processing device 12 calculates ratios R11 and R12 of the first block, the second block, and the third block. The ratios R11, R12, and R13 of the blocks based on the virtual area Vs' of the first block can be expressed by Expressions 4, 5, and 6.

R11=Vs1/Vs1=1 (Expression 4)

R12=Vs2/Vs1=g2/g1 (Expression 5)

R13=Vs3/Vs1=g3/g1 (Expression 6)

The state of the target object 4 can be detected using the ratios R11, R12, and R13 of the blocks.

In addition, whether the target object 4 is normal or abnormal may be detected using state information indicating the state of the target object 4 detected using the ratios R11, R12, and R13 of the blocks.

### j) Detection of Variation in Distance Information Distribution

The processing device 12 performs comparison between frames using the ratios R11, R12, and R13 of the respective blocks, and detects a variation in the distance information distribution in the distance image Gd from the difference ΔR between the ratios R11, R12, and R13.

### k) Presence and State Detection of Target Object 4

The processing device 12 obtains a variation amount M indicating the variation amount in the distance information distribution detected from the distance image Gd, compares the variation amount M with a threshold Mth for detecting an abnormality, and detects the presence and the state of the target object 4. In this case, since the state is detected based on the presence or absence of the behavior of the target object 4, when the variation amount M is more than the threshold Mth (M>Mth), normal is detected, and when the variation amount M is equal to or less than the threshold Mth (M≤Mth), abnormality is detected.

The state detection, the abnormality detection, or the normal detection of the target object 4 may use a combination of the ratios R11, R12, and R13 of the blocks and the above-described j) detection of the variation in the distance information distribution. In this case, for example, the normality or abnormality of the target object 4 may be detected by changing from a specific state a to a specific state b.

### l) Presentation of Distance Image, Virtual Area Image, State Information, and Determination Information

The processing device 12 presents the distance image Gd, the virtual area for each block, the state information, and the determination information to the information presentation unit 28 under the control of the processor 22. According to these pieces of presentation information, it is possible to visually recognize the determination information indicating the presence and the state of the target object 4, and whether the state of the target object 4 is normal or abnormal.

For this information presentation, under the control of the processor 22 from the processing device 12, the communication unit 30 and the corresponding communication terminal can be wirelessly connected, and information presentation similar to that of the information presentation unit 28 can be performed on the communication terminal.

### m) Generation and Update of Detection Information Database 32-1

The processing device 12 generates and updates the detection information database 32-1 stored in the storage unit 24 under the control of the processor 22.

### <Detection Information Database 32-1>

The detection information database 32-1 stores control information of the control unit 10 for detecting the state of the target object 4, control information of the processing device 12, processing information of the distance image Gd, state detection information of the target object 4, and the like.

FIG. 2 illustrates the detection information database 32-1 (hereinafter simply referred to as a “database 32-1”) that stores detection information.

The database 32-1 is an example of the database of the present disclosure. The database 32-1 includes a date-and-time information unit 34, a light emission information unit 36, a light reception information unit 38, a distance image unit 40, a division information unit 42, a block image information unit 44, a virtual area/ratio unit 46, a distance information distribution unit 48, a variation amount information unit 49, a state information unit 50, a detection information unit 52, a presentation information unit 54, and a history information unit 56.

The date-and-time information unit 34 stores date-and-time information indicating the date and time of state detection of the target object 4.

The light emission information unit 36 stores specification information, light emission timing, light emission control information, and the like of a light emitting element of the light emitting unit 6.

The light reception information unit 38 stores specification information, light reception timing, light reception control information, and the like of a light receiving element of the light receiving unit 16.

The distance image unit 40 stores image information indicating the distance image Gd generated by the distance image generation unit 18 using the light reception information.

The division information unit 42 stores division information such as distance information indicating a distance relationship, i.e. far and near relationship, for dividing the distance image Gd into, for example, a first block, a second block, and a third block.

A first block unit 44-1, a second block unit 44-2, and a third block unit 44-3 are set in the block image information unit 44. The first block unit 44-1 stores image information indicating image information Gd1 corresponding to the first block, the second block unit 44-2 stores image information indicating image information Gd2 corresponding to the second block, and the third block unit 44-3 stores image information indicating image information Gd3 corresponding to the third block.

The virtual area/ratio unit 46 stores, for example, image information indicating the virtual area Vs1 of the first block, the virtual area Vs2 of the second block, and the virtual area Vs3 of the third block, and ratio information indicating ratios R11, R12, and R13 of the first block, the second block, and the third block based on the virtual area Vs1 of the first block.

The distance information distribution unit 48 stores distribution information indicating the distance information distribution of the first block, the second block, and the third block.

The variation amount information unit 49 stores variation amount information indicating a change in behavior such as repetition of the operation of the target object 4. The variation amount across this block may also be included.

The state information unit 50 stores state information indicating the state of the target object 4 associated with the variation amount information unit 49.

The detection information unit 52 stores detection information indicating whether the state of the target object 4 determined from the distance information distribution or the like.

The presentation information unit 54 stores presentation information such as the distance image Gd presented in the information presentation unit 28.

The history information unit 56 stores information indicating a processing history including state detection and the like.

### <Processing Procedure for State Detection of Target Object 4>

This processing procedure is a processing procedure of state detection using the distance image Gd acquired by the imaging of the detection module 20.

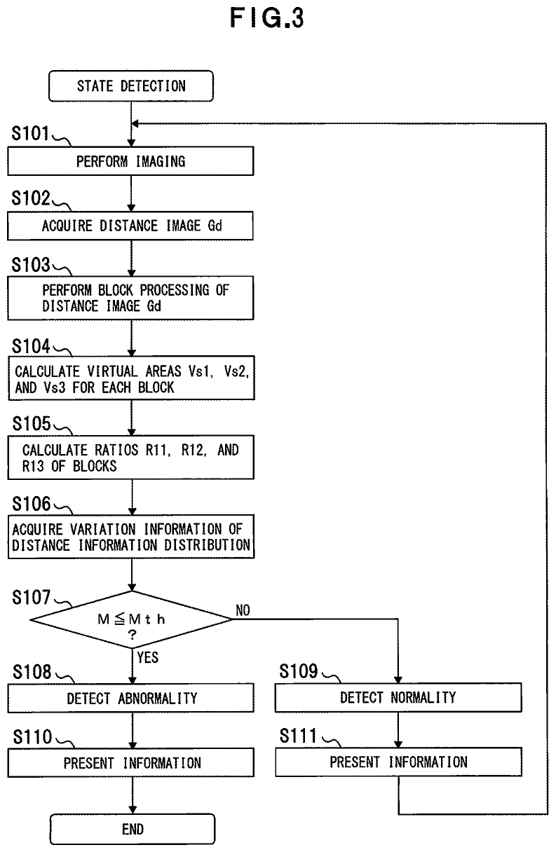

FIG. 3 illustrates a processing procedure of state detection of the target object 4. This processing procedure includes imaging (S101), acquisition of the distance image Gd (S102), block processing of the distance image Gd (S103), calculation of the virtual areas Vs1, Vs2, and Vs3 for each block (S104), calculation of the ratios R11, R12, and R13 of blocks (S105), acquisition of variation information of the distance information distribution (S106), threshold determination of the variation amount M (S107), abnormality detection (S108), normality detection (S109), and information presentation (S110, S111).

According to this processing procedure, the imaging unit 8 images the target object 4 under the control of the control unit 10 (S101). In the imaging unit 8, the distance image generation unit 18 acquires the light reception signal from the light receiving unit 16, and generates the distance image Gd indicating the target object 4 from the light reception signal.

The processing device 12 acquires the distance image Gd from the control unit 10 of the detection module 20 under the control of the processor 22 (S102).

The processing device 12 executes block processing of the distance image Gd by the information processing of the processor 22, and divides the distance image Gd into a first block 60-1, a second block 60-2, and a third block 60-3 (FIG. 5B) (S103).

The processing device 12 calculates the virtual areas Vs1, Vs2, and Vs3 for each block using the distance image Gd subjected to the block processing by the information processing of the processor 22 (S104).

The processing device 12 calculates ratios R11, R12, and R13 of the blocks by the information processing of the processor 22 (S105).

By the information processing of the processor 22, the processing device 12 acquires the variation information of the distance information distribution for each state by the comparison calculation using the ratios R11, R12, and R13 of the blocks (S106).

By the information processing of the processor 22, the processing device 12 acquires the variation amount M, compares the variation amount M with the threshold Mth, and determines a magnitude relationship between the variation amount M and the threshold Mth (S107).

By the information processing of the processor 22, when M≤Mth (YES in S107), the processing device 12 determines that the target object 4 does not behave and an abnormality is detected (S108). When M>Mth (NO in S107), it is determined that the target object 4 behaves, and a normality is detected (S109).

The processing device 12 executes information presentation (S110, S111) under the control of the processor 22, and information such as detection information indicating abnormality and the distance image Gd is presented in the information presentation according to S110. Information such as detection information indicating normality and the distance image Gd is presented in the information presentation according to S111.

Then, in a case where there is an abnormality in the target object 4, this processing ends, and in a case where the target object is normal, the process returns from S111 to S101, and the state detection is continued.

### <Behavior of Target Object 4>

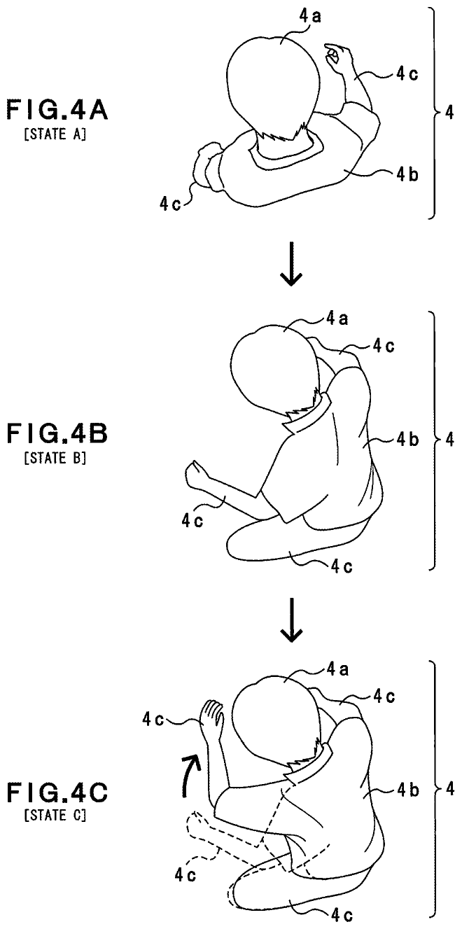

The target object 4 for state detection is, for example, a human, but the distance image Gd obtained from the detection module 20 is a set of pixels gi indicating the distance between the light receiving unit 16 and the target object 4. Therefore, in order to simulate the state detection of the target object 4, as an example, a real image of the target object 4 is clearly illustrated as illustrated in FIG. 4, and the behavior of the target object 4 is presented.

This behavior includes, for example, a state A (FIG. 4A), a state B (FIG. 4B), and a state C (FIG. 4C).

As illustrated in FIG. 4A, the state A is a view illustrating a standing state of the target object 4 as viewed from the light receiving unit 16 above the head.

As illustrated in FIG. 4B, the state B is a view illustrating a squatting state of the target object 4 shifted from the state A as viewed from the light receiving unit 16 above the head.

As illustrated in FIG. 4C, the state C is a view illustrating a squatting state of the target object 4 shifted from the state B as viewed from the light receiving unit 16 above the head. A broken line indicates the movement of the limb 4c, specifically, the movement of the left arm.

In the behavior of the target object 4, as a simulation of state detection, a state in which the behavior of the target object 4 stops in the state B and there is no fluctuation even after a certain period of time, for example, is determined to be an abnormal state. Meanwhile, when a behavior, e.g. transition from the state B to the state C, occurs in the target object 4, it is determined as a normal state.

### <Behavior of Target Object 4 and State Detection Thereof

This state detection is state detection using the variation amount information stored in the variation amount information unit 49 of the database 38-1 described above.

By comparing at least previous and following frames for the variation amount of the target object 4, it can be used for state detection and periodicity detection of the target object 4. The variation amount information unit 49 may store allowable value information indicating an allowable value for the detected periodicity, and the abnormal state of the target object 4 may be determined by using a variation amount exceeding the allowable value. The allowable value may also include an elapsed time, a variation amount, and the number of variations. For example, in a case where the behavior of the limb of the target object 4, e.g. the left arm, is stopped, the behavior in which the right arm is moving may be determined as the abnormal state. By comparing transition and trajectory of the variation amount information recorded in the variation amount information unit 49 with a standard, the order of the state of the target object 4 and the like can be detected. For example, in a case where the order of the behavior detected from the target object 4 is different from that of a previous behavior, when the allowable value is set in the behavior range, it can be determined as an abnormal state. When the previous behavior of the left arm of the target object 4 is a transition from the state C via the state A to the state B illustrated in FIGS. 4A to 4C, for example, and the current behavior of the left arm is a transition from the state C via the state B to the state A, it is possible to perform processing of determining that the behavior different from the previous behavior is the abnormal state, and the variation amount information stored in the variation amount information unit 49 can be effectively utilized.

<Distance Image Gd-B of State B, First Block 60-1, Second Block 60-2, and Third Block 60-3 of Distance Image Gd-B, Virtual Area Images Gs1-B, Gs2-B, and Gs3-B for Each Block, Virtual Areas Vs1-B, Vs2-B, and Vs3-B, and Ratios R11-B, R12-B, and R13-B>

FIG. 5A illustrates a distance image Gd-B on the frame 58-1 obtained from the state B (FIG. 4B) of the target object 4. The distance image Gd-B includes pixels gi corresponding to the first block 60-1, pixels gi corresponding to the second block 60-2, and pixels gi corresponding to the third block 60-3.

FIG. 5B illustrates virtual area images Gs1-B, Gs2-B, and Gs3-B generated from the distance image Gd-B. The virtual area image Gs1-B indicates a part of the target object 4 calculated from the pixels gi included in the first block 60-1 of the state B and a virtual area thereof. The virtual area image Gs2-B indicates a part of the target object 4 calculated from the pixels gi included in the second block 60-2 in the state B and a virtual area thereof. The virtual area image Gs3-B indicates a part of the target object 4 calculated from the pixels gi included in the third block 60-3 of the state B and a virtual area thereof.

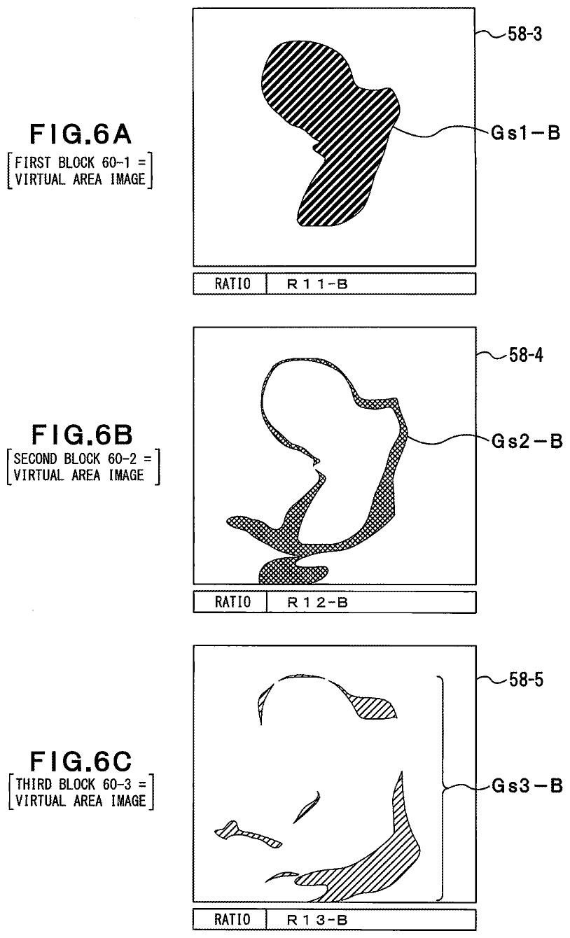

FIG. 6A illustrates a virtual area image Gs1-B corresponding to the first block 60-1 on a frame 58-3 separated from the virtual area image Gs-B. The virtual area Vs1-B of the first block 60-1 can be calculated by the pixels gi included in the virtual area image Gs1-B. In this case, the ratio R11 is R11-B.

FIG. 6B illustrates a virtual area image Gs2-B corresponding to the second block 60-2 on a frame 58-4 separated from the virtual area image Gs-B. The virtual area Vs2-B of the second block 60-2 can be calculated by the pixels gi included in the virtual area image Gs2-B. In this case, the ratio R12 is R12-B.

FIG. 6C illustrates a virtual area image Gs3-B corresponding to the third block 60-3 on a frame 58-5 separated from the virtual area image Gs-B. The virtual area Vs3-B of the third block 60-3 can be calculated by the pixels gi included in the virtual area image Gs3-B. In this case, the ratio R13 is R13-B.

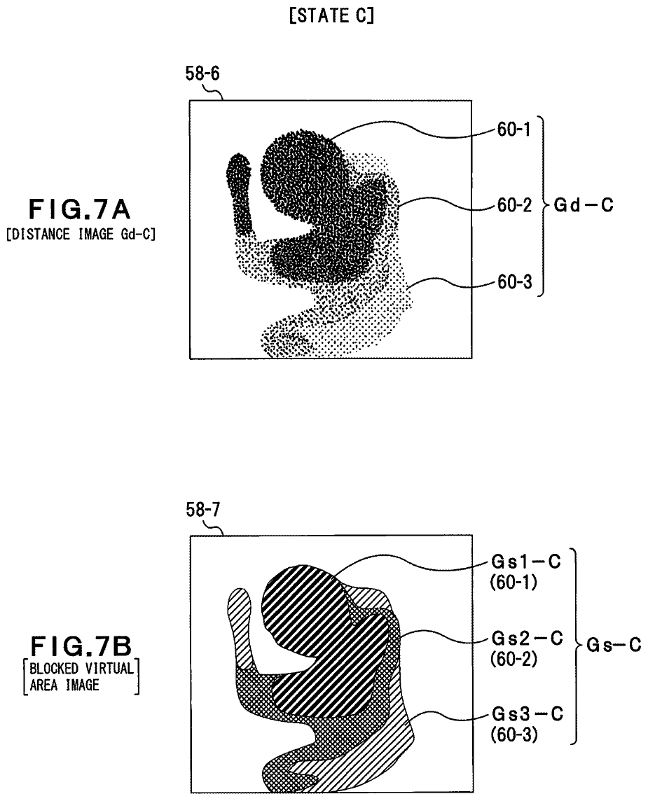

FIG. 7A illustrates a distance image Gd-C on a frame 58-6 obtained from the state C (FIG. 4C) of the target object 4. The distance image Gd-C includes pixels gi corresponding to the first block 60-1, pixels gi corresponding to the second block 60-2, and pixels gi corresponding to the third block 60-3.

FIG. 7B indicates the virtual area images Gs1-C, Gs2-C, and Gs3-C generated from the distance image Gd-C in which the pixels gi included in the virtual area image Gs-C are blocked on a frame 58-7 according to the distance relationship, i.e. far and near relationship. The virtual area image Gs1-C indicates a part of the target object 4 calculated from the pixels gi included in the first block 60-1 in the state C and a virtual area thereof. The virtual area image Gs2-C indicates a part of the target object 4 calculated from the pixels gi included in the second block 60-2 in the state C and a virtual area thereof. The virtual area image Gs3-C indicates a part of the target object 4 calculated from the pixels gi included in the third block 60-3 in the state C and the virtual area thereof.

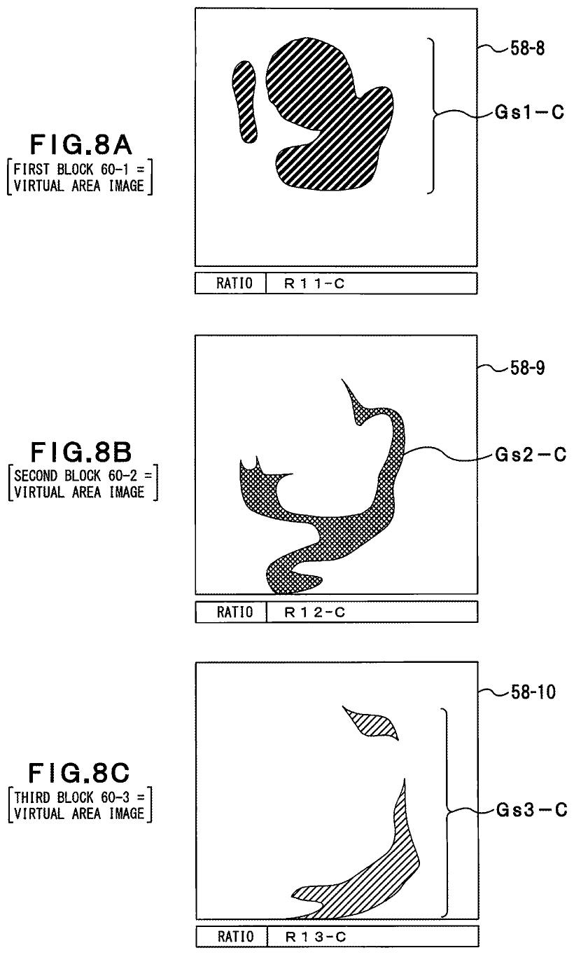

FIG. 8A illustrates a virtual area image Gs1-C corresponding to the first block 60-1 on a frame 58-8 separated from the virtual area image Gs-C. The virtual area Vs1-C of the first block 60-1 can be calculated by the pixels gi included in the virtual area image Gs1-C. In this case, the ratio R11 is R11-C.

FIG. 8B illustrates a virtual area image Gs2-C corresponding to the second block 60-2 on a frame 58-9 separated from the virtual area image Gs-C. The virtual area Vs2-C of the second block 60-2 can be calculated by the pixels gi included in the virtual area image Gs2-C. In this case, the ratio R12 is R12-C.

FIG. 8C illustrates a virtual area image Gs3-C corresponding to the third block 60-3 on a frame 58-10 separated from the virtual area image Gs-C. The virtual area Vs3-C of the third block 60-3 can be calculated by the pixels gi included in the virtual area image Gs3-C. In this case, the ratio R13 is R13-C.

### <Comparison Calculation and Determination of Variation Information of Distance Information Distribution of States B and C>

The comparison calculation of the variation information of the distance information distributions in the states B and C is detection of whether the target object 4 is normal or abnormal. When the ratios R11-B, R12-B, and R13-B illustrated in FIGS. 6A, 6B, and 6C obtained from the state B are compared with the ratios R11-C, R12-C, and R13-C illustrated in FIGS. 8A, 8B, and 8C obtained from the state C, in the state C, as illustrated in FIG. 8A, since the arm portion of the limb 4c of the target object 4 is added to the distance image Gd1-B of the first block 60-1, the virtual area Vs1-C is enlarged, and as illustrated in FIG. 8C, the distance image Gd3-C of the third block 60-3 is changed, and the virtual area Vs3-C is reduced.

In this case, when the variation amount M is acquired from the variation information of the distance information distribution in the states B and C by the processing described above and the variation amount M is compared with the threshold Mth, it is determined that M>Mth is satisfied in the states B and C, and the behavior of the target object 4 is present, the normality is detected.

In this case, when the variation amount M is acquired from the variation information of the distance information distribution in the states B and C by the processing described above, the variation amount M is compared with the threshold Mth, and M≤Mth is satisfied, it is determined that there is no behavior of the target object 4, and the abnormality is detected.

### <Effects of First Embodiment>

According to the first embodiment, any one of the following effects can be obtained.

(1) The pixels gi included in the distance image Gd is divided into the first block 60-1, the second block 60-2, and the third block 60-3 according to the distance relationship, i.e. far and near relationship, the virtual areas Vs1-B, Vs2-B, Vs3-B, Vs1-C, Vs2-C, and Vs3-C in the states B and C are calculated using the pixels gi for each of the first block 60-1, the second block 60-2, and the third block 60-3, and the ratios R11-B, R12-B, and R13-B in the state B and the ratios R11-C, R12-C, and R13-C in the state C are compared with each other, so that the state of the target object 4 can be detected easily and with high accuracy.

(2) Since the state of the target object 4 is detected by the ratios R11-B, R12-B, and R13-B in the state B and the ratios R11-C, R12-C, and R13-C in the state C of the virtual areas Vs1-B, Vs2-B, Vs3-B, Vs1-C, Vs2-C, and Vs3-C for each block, when the target object 4 is, for example, a human, attribute information such as gender, that is, information other than the state of the target object, can be omitted, information used for detection processing can be reduced, the load of information processing can be reduced, and processing can be speeded up.

(3) The state of the target object 4 can be detected by comparing frames indicating the distance images Gd1-B, Gd2-B, and Gd3-B and the distance images Gd1-C, Gd2-C, and Gd3-C divided from the distance image Gd into the first block 60-1, the second block 60-2, and the third block 60-3.

### Second Embodiment

In the second embodiment, the virtual volumes Vv1, Vv2, and Vv3 of the target object 4 divided into the first block 60-1, the second block 60-2, and the third block 60-3 are calculated from the distance image Gd, and the state of the target object 4 is detected.

### <Detection System 2 According to Second Embodiment>

The detection system 2 according to the second embodiment has the same configuration as the configuration illustrated in FIG. 1, and thus description thereof is omitted.

### <Control by Control Unit 10 According to Second Embodiment>

Similarly, the control by the control unit 10 according to the second embodiment includes processing such as a) light emission control of the light Li, b) light reception control of the reflected light Lf, c) generation processing of the distance image Gd, and d) transmission of the distance image Gd.

### <Information Processing by Processing Device 12 According to Second Embodiment>

The information processing of the processing device 12 includes processing such as n) acquisition of the distance image Gd, o) division of the distance image Gd, p) generation of a virtual volume image Gv, q) calculation of the virtual volume for each block, r) calculation of the ratios of blocks, s) detection of variation in the distance information distribution, t) presence and state detection of the target object 4, u) presentation of the distance image, the virtual volume image, the state information, and the determination information, and v) generation and update of the detection information database 32-2.

### n) Acquisition of Distance Image Gd

The processing device 12 acquires the distance images Gd in time sequence under the control of the processor 22. The distance image Gd is executed in units of frames.

### o) Division of Distance Image Gd

Under the control of the processor 22, the processing device 12 divides a plurality of pixels gi included in the distance image Gd into two or more blocks according to a distance relationship, i.e. far and near relationship. This division is, for example, divided into a first block, a second block, and a third block.

### p) Generation of Virtual Volume Image Gv

The processing device 12 generates the virtual volume image Gv for each block from the distance image Gd divided into blocks under the control of the processor 22.

### q) Calculation of Virtual Volume for Each Block

The processing device 12 calculates virtual volumes Vv1, Vv2, and Vv3 for each of the first block, the second block, and the third block for at least each state of the target object 4 using the pixels gi included in the first block, the second block, and the third block.

Assuming that g1 is the number of the pixels gi included in the first block, that g2 is the number of the pixels gi included in the second block, that g3 is the number of the pixels gi included in the third block, and that q is a conversion coefficient for converting the number of the pixels gi into a volume, the virtual volume Vv1 of the first block, the virtual volume Vv2 of the second block, and the virtual volume Vv3 of the third block can be expressed by Expressions 7, 8, and 9.

Vv1=qg1 (Expression 7)

Vv2=qg2 (Expression 8)

Vv3=qg3 (Expression 9)

### r) Calculation of Ratios R11, R12, R13 of Blocks

The processing device 12 calculates ratios R11, R12, and R13 of the first block, the second block, and the third block. Ratios R11, R12, and R13 of the blocks based on the virtual volume Vv1 of the first block can be expressed by Expressions 10, 11, and 12.

R11=Vv1/Vv1=1 (Expression 10)

R12=Vv2/Vv1=g2/g1 (Expression 11)

R13=Vv3/Vv1=g3/g1 (Expression 12)

The state of the target object 4 can be detected using the ratios R11, R12, and R13 of the blocks.

In addition, whether the target object 4 is normal or abnormal may be detected using state information indicating the state of the target object 4 detected using the ratios R11, R12, and R13 of the blocks.

### s) Detection of Variation in Distance Information Distribution

The processing device 12 performs comparison between frames using the ratios R11, R12, and R13 of the respective blocks, and detects a variation in the distance information distribution in the distance image Gd from the difference ΔR between the ratios R11, R12, and R13.

### t) Presence and State Detection of Target Object 4

The processing device 12 obtains a variation amount M indicating the variation amount in the distance information distribution detected from the distance image Gd, compares the variation amount M with a threshold Mth for detecting an abnormality, and detects the presence and the state of the target object 4. In this case, since the state is detected based on the presence or absence of the behavior of the target object 4, when the variation amount M is equal to or more than the threshold Mth (M≥Mth), the normal is detected, and when the variation amount M is less than the threshold Mth (M<Mth), the abnormality is detected.

The state detection, the abnormality detection, or the normal detection of the target object 4 may use a combination of the ratios R11, R12, and R13 of the blocks and the above-described s) detection of the variation in the distance information distribution. In this case, for example, the normality or abnormality of the target object 4 may be detected by changing from a specific state a to a specific state b.

### u) Presentation of Distance Image, Virtual Volume Image, State Information, and Determination Information

The processing device 12 presents the distance image Gd, the virtual volume for each block, the state information, and the determination information to the information presentation unit 28 under the control of the processor 22. According to these pieces of presentation information, it is possible to visually recognize the determination information indicating the presence and the state of the target object 4, and whether the state of the target object is normal or abnormal.

For this information presentation, under the control of the processor 22 from the processing device 12, the communication unit 30 and the corresponding communication terminal can be wirelessly connected, and information presentation similar to that of the information presentation unit 28 can be performed on the communication terminal.

### v) Generation and Update of Detection Information Database 32-2

The processing device 12 generates and updates the detection information database 32-2 stored in the storage unit 24 under the control of the processor 22.

### <Detection Information Database 32-2>

Similarly to the first embodiment, the detection information database 32-2 stores control information of the control unit 10 for detecting the state of the target object 4, control information of the processing device 12, processing information of the distance image Gd, state detection information of the target object 4, and the like.

FIG. 9 illustrates a detection information database 32-2 (hereinafter simply referred to as a “database 32-2”) that stores detection information.

The database 32-2 is an example of the database of the present disclosure. In the database 32-2, the same portions as those of the database 32-1 are denoted by the same reference numerals. The database 32-2 includes the date-and-time information unit 34, the light emission information unit 36, the light reception information unit 38, the distance image unit 40, the division information unit 42, the block image information unit 44, a virtual volume/ratio unit 47, a distance information distribution unit 48, a state information unit 50, a detection information unit 52, a presentation information unit 54, and a history information unit 56.

Since the date-and-time information unit 34, the light emission information unit 36, the light reception information unit 38, the distance image unit 40, the division information unit 42, the block image information unit 44, the distance information distribution unit 48, the state information unit 50, the detection information unit 52, the presentation information unit 54, and the history information unit 56 are the same as those of the database 32-1, the description thereof will be omitted.

The virtual volume/ratio unit 47 stores, for example, image information indicating the virtual volume Vv1 of the first block, the virtual volume Vv2 of the second block, and the virtual volume Vv3 of the third block, and ratio information indicating ratios R11, R12, and R13 of the first block, the second block, and the third block based on the virtual volume Vv1 of the first block.

### <Processing Procedure for State Detection of Target Object 4>

Similarly to the first embodiment, this processing procedure is a processing procedure of state detection using the distance image Gd acquired by imaging by the detection module 20.

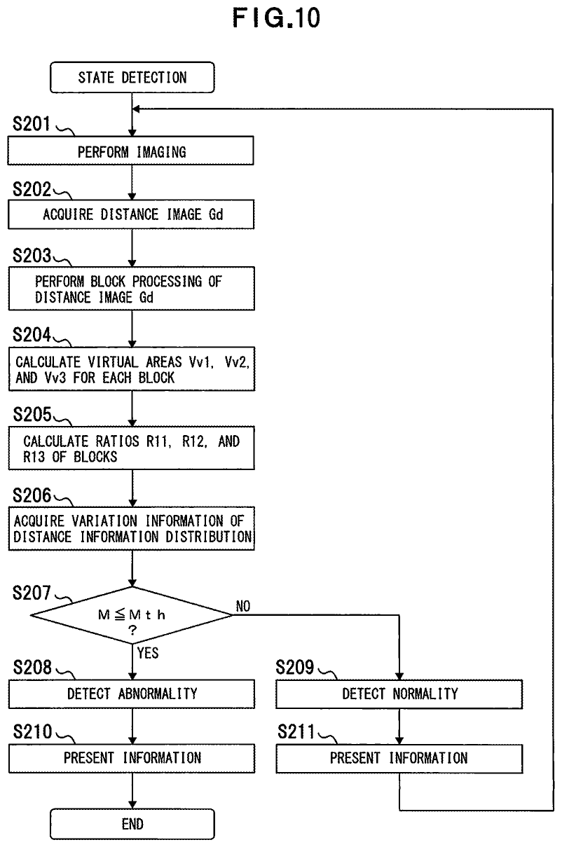

FIG. 10 illustrates a processing procedure of state detection of the target object 4. This processing procedure includes imaging (S201), acquisition of the distance image Gd (S202), block processing of the distance image Gd (S203), calculation of the virtual volumes Vv1, Vv2, and Vv3 for each block (S204), calculation of the ratios R11, R12, and R13 of blocks (S205), acquisition of variation information of the distance information distribution (S206), threshold determination of the variation amount M (S207), abnormality detection (S208), normality detection (S209), and information presentation (S210, S211).

According to this processing procedure, the imaging unit 8 images the target object 4 under the control of the control unit 10 (S201). In the imaging unit 8, the distance image generation unit 18 acquires the light reception signal from the light receiving unit 16, and generates the distance image Gd indicating the target object 4 from the light reception signal.

The processing device 12 acquires the distance image Gd from the control unit 10 of the detection module 20 under the control of the processor 22 (S202).

The processing device 12 executes block processing of the distance image Gd by the information processing of the processor 22, and divides the distance image Gd into the first block 60-1, the second block 60-2, and the third block 60-3 (FIG. 5B) (S203).

The processing device 12 calculates the virtual volumes Vv1, Vv2, and Vv3 for each block using the distance image Gd subjected to the block processing by the information processing of the processor 22 (S204).

The processing device 12 calculates ratios R11, R12, and R13 of the blocks by the information processing of the processor 22 (S205).

By the information processing of the processor 22, the processing device 12 acquires the variation information of the distance information distribution for each state by the comparison calculation using the ratios R11, R12, and R13 of the blocks (S206).

By the information processing of the processor 22, the processing device 12 acquires the variation amount M, compares the variation amount M with the threshold Mth, and determines a magnitude relationship between the variation amount M and the threshold Mth (S207).

By the information processing of the processor 22, when M≤Mth (YES in S207), the processing device 12 determines that the target object 4 does not behave and the abnormality is detected (S208). When M>Mth (NO in S207), it is determined that the target object 4 behaves, and a normality is detected (S209).

The processing device 12 executes information presentation (S210, S211) under the control of the processor 22, and information such as detection information indicating abnormality and the distance image Gd is presented in the information presentation according to S210. Information such as detection information indicating normality and the distance image Gd is presented in the information presentation according to S211.

Then, in a case where there is an abnormality in the target object 4, this processing is ended, and in a case where the target object is normal, the process returns from S211 to S201, and the state detection is continued.

### <Behavior of Target Object 4>

The state detection target object 4 is the same as that in the first embodiment, description thereof is omitted, and the state A (FIG. 4A), the state B (FIG. 4B), and the state C (FIG. 4C) are referred to for behavior.

<Distance Image Gd-B of State B, First Block 60-1, Second Block 60-2, and Third Block 60-3 of Distance Image Gd-B, Virtual Volume Images Gv1-B, Gv2-B, and Gv3-B for Each Block, Virtual Volumes Vv1-B, Vv2-B, and Vv3-B, and Ratios R11-B, R12-B, and R13-B>

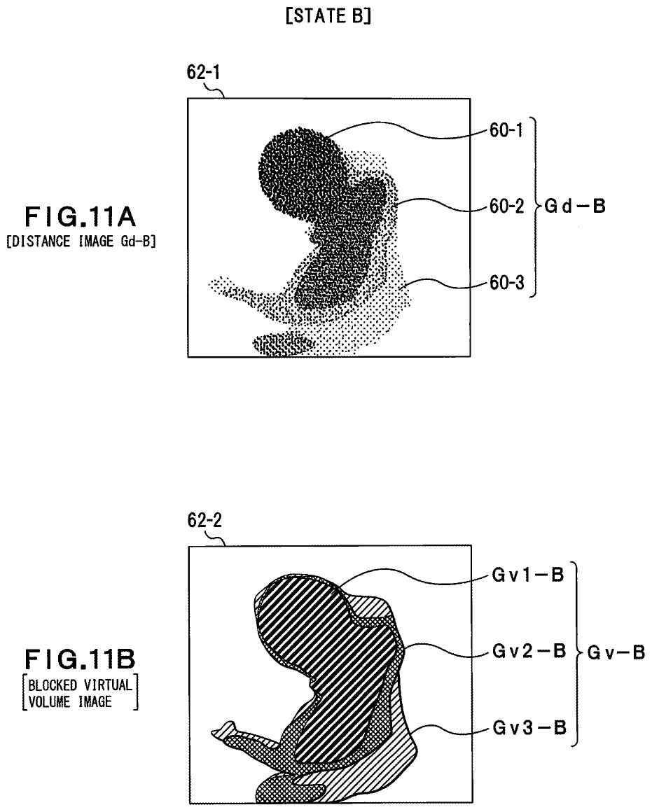

FIG. 11A illustrates the distance image Gd-B on the frame 62-1 obtained from the state B (FIG. 4B) of the target object 4. The distance image Gd-B includes pixels gi corresponding to the first block 60-1, pixels gi corresponding to the second block 60-2, and pixels gi corresponding to the third block 60-3.

FIG. 11B illustrates virtual volume images Gv1-B, Gv2-B, and Gv3-B generated from the distance image Gd-B. The virtual volume image Gv1-B indicates a part of the target object 4 calculated from the pixels gi included in the first block 60-1 of the state B and a virtual volume thereof. The virtual volume image Gv2-B indicates a part of the target object 4 calculated from the pixels gi included in the second block 60-2 of the state B and a virtual volume thereof. The virtual volume image Gv3-B indicates a part of the target object 4 calculated from the pixels gi included in the third block 60-3 of the state B and a virtual volume thereof.

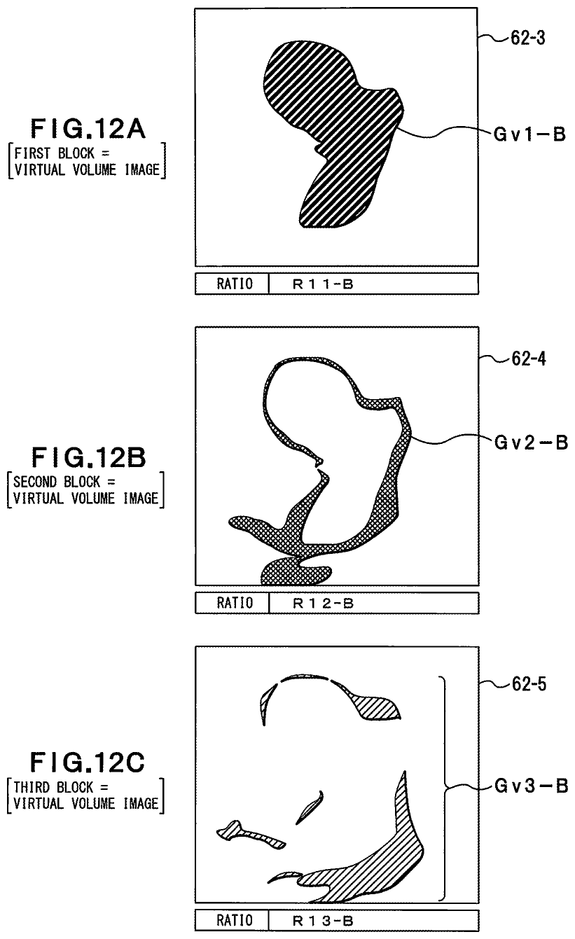

FIG. 12A illustrates a virtual volume image Gv1-B corresponding to the first block 60-1 on a frame 62-3 separated from the virtual volume image Gv-B. The virtual volume Vv1-B of the first block 60-1 can be calculated by the pixels gi included in the virtual volume image Gv1-B. In this case, the ratio R11 is R11-B.

FIG. 12B illustrates a virtual volume image Gv2-B corresponding to the second block 60-2 on a frame 62-4 separated from the virtual volume image Gv-B. The virtual volume Vv2-B of the second block 60-2 can be calculated by the pixels gi included in the virtual volume image Gv2-B. In this case, the ratio R12 is R12-B.

FIG. 12C illustrates a virtual volume image Gv3-B corresponding to the third block 60-3 on a frame 62-5 separated from the virtual volume image Gv-B. The virtual volume Vv3-B of the third block 60-3 can be calculated by the pixels gi included in the virtual volume image Gv3-B. In this case, the ratio R13 is R13-B.

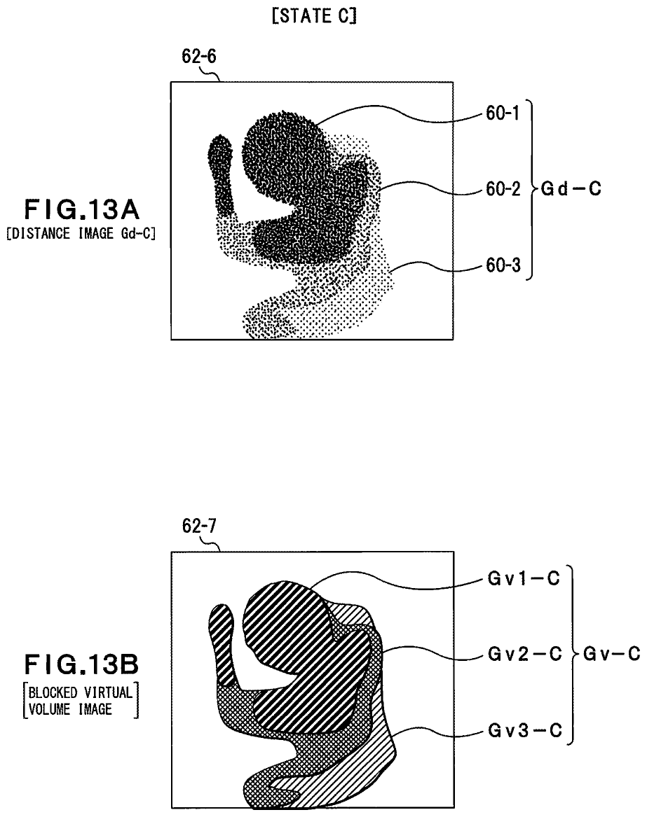

FIG. 13A illustrates a distance image Gd-B on the frame 62-1 obtained from the state C (FIG. 4C) of the target object 4. The distance image Gd-C includes pixels gi corresponding to the first block 60-1, pixels gi corresponding to the second block 60-2, and pixels gi corresponding to the third block 60-3.

FIG. 13B illustrates virtual volume images Gv1-C, Gv2-C, and Gv3-C generated from the distance image Gd-B. The virtual volume image Gv1-C indicates a part of the target object 4 calculated from the pixels gi included in the first block 60-1 in the state C and a virtual volume thereof. The virtual volume image Gv2-C indicates a part of the target object 4 calculated from the pixels gi included in the second block 60-2 in the state C and a virtual volume thereof. The virtual volume image Gv3-C indicates a part of the target object 4 calculated from the pixels gi included in the third block 60-3 in the state C and a virtual volume thereof.

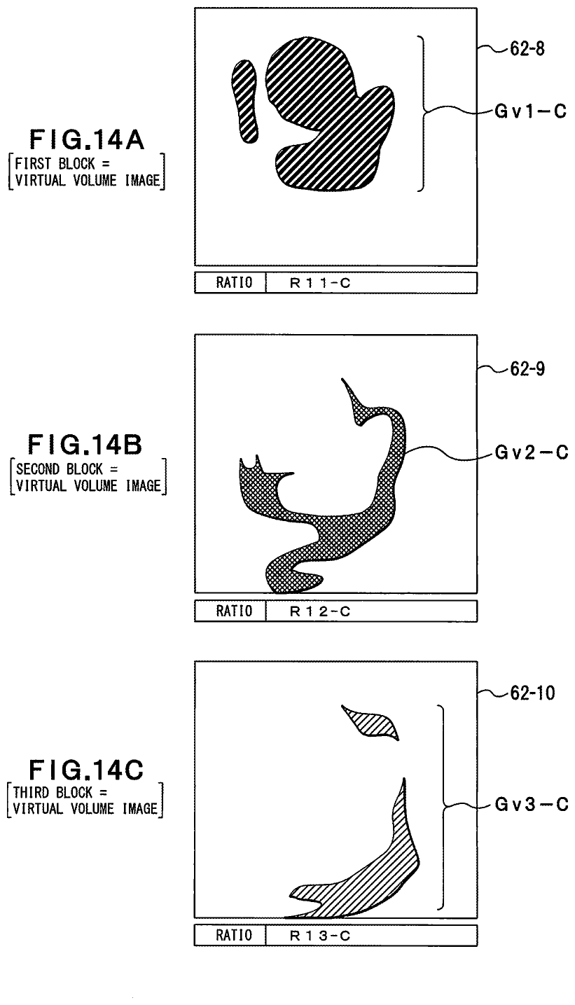

FIG. 14A illustrates a virtual volume image Gv1-C corresponding to the first block 60-1 on a frame 62-8 separated from the virtual volume image Gv-C. The virtual volume Vv1-C can be calculated from the pixels gi included in the virtual volume image Gv1-C. In this case, the ratio R11 is R11-C.

FIG. 14B illustrates a virtual volume image Gv2-C corresponding to the second block 60-2 on a frame 62-9 separated from the virtual volume image Gv-C. The virtual volume Vv2-C can be calculated from the pixels gi included in the virtual volume image Gv2-C. In this case, the ratio R12 is R12-C.

FIG. 14C illustrates a virtual volume image Gv3-C corresponding to the third block 60-3 on a frame 62-10 separated from the virtual volume image Gv-C. The virtual volume Vv3-C can be calculated from the pixels gi included in the virtual volume image Gv3-C. In this case, the ratio R13 is R13-C.

### <Comparison Calculation and Determination of Variation Information of Distance Information Distribution of States B and C>

The comparison calculation of the variation information of the distance information distributions in the states B and C is the detection of whether the target object 4 is normal or abnormal similarly to the first embodiment. When the ratios R11-B, R12-B, and R13-B illustrated in FIGS. 12A, 12B, and 12C obtained from the state B are compared with the ratios R11-C, R12-C, and R13-C illustrated in FIGS. 14A, 14B, and 14C obtained from the state C, in the state C, as illustrated in FIG. 14A, since the arm portion of the limb 4c of the target object 4 is added to the virtual volume image Gv1-C of the first block, the virtual volume Vv1-C is enlarged, and as illustrated in FIG. 14C, the virtual volume image Gv3-C of the third block is changed and the virtual volume Vv3-C is reduced.

Therefore, when the variation amount M is acquired from the variation information of the distance information distribution in the states B and C by the processing described above, and the variation amount M is compared with the threshold Mth, it is determined that M>Mth is satisfied in the states B and C, and the behavior of the target object 4 is present, the normality is detected.

In this case, when the variation amount M is acquired from the variation information of the distance information distribution in the states B and C by the processing described above, the variation amount M is compared with the threshold Mth, and M≤Mth is satisfied, it is determined that there is no behavior of the target object 4, and the abnormality is detected.

### <Effects of Second Embodiment>

According to the second embodiment, any one of the following effects can be obtained.

(1) Effects similar to those of the first embodiment can be obtained.

(2) In the second embodiment, the state of the target object 4 is detected by the ratios R11-B, R12-B, and R13-B of the state B of the virtual volumes Vv1-B, Vv2-B, and Vv3-B and the ratios R11-C, R12-C, and R13-C of the state C of the virtual volumes Vv1-C, Vv2-C, and Vv3-C. Therefore, in a case where the target object 4 is, for example, a human, the state can be detected in consideration of the information in the thickness direction of the target object 4, and the detection accuracy can be further improved.

### Example

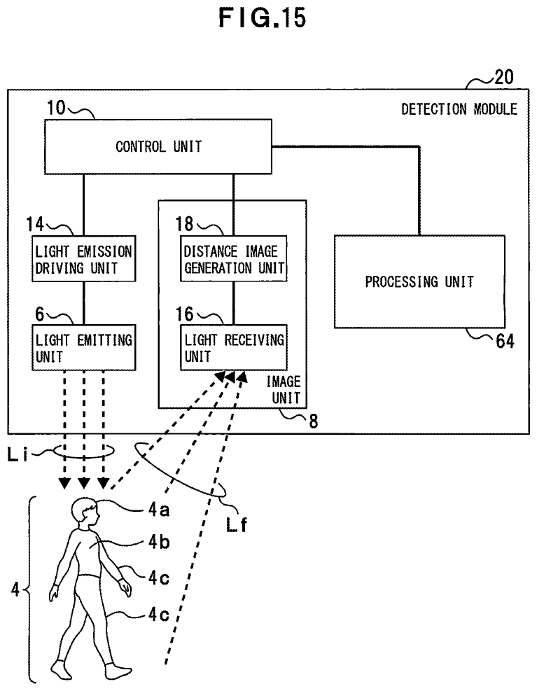

FIG. 15 exemplifies conversion of the detection module 20 into one chip. The detection module 20 includes a processing unit 64 having a function equivalent to that of the processing device 12. In the detection module 20, the same reference numerals are given to the same parts as those of the detection system 2 described above, and the description thereof will be omitted.

### <Effects of Example>

According to this example, any one of the following effects can be obtained.

(1) It can be widely used for detecting the state of the target object 4 such as a human.

(2) The state of the target object 4 can be detected without considering privacy such as gender, and can be used for state detection in a bathroom, a toilet, or the like.

### Other Embodiments

The present disclosure includes the following modifications.

(1) In the detection system 2, the processing device 12 may compare coordinates of the pixels gi included in the two or more distance images Gd, the virtual area images Gs, or the virtual volume images Gv, and detect the state variation of the target object 4 from a difference between previous and following coordinates.

(2) In the detection system 2, the coordinates on the image may include any of coordinates of a singular point (including a feature point of the target object 4), a centroid point, or a vertex included in the distance image Gd, the virtual area image Gs, or the virtual volume image Gv.

(3) In the above embodiments, the distance image is divided into three blocks of the first block, the second block, and the third block, but two or four or more divisions may be applied using the distance image obtained from the target object 4.

(4) In the above embodiments, a human is exemplified as the target object 4, but a moving body other than a human, for example, a moving body such as an automobile or a robot may be used as the target object 4.

(5) In the above embodiments, a single detection module is exemplified. However, a plurality of detection modules obtained using a plurality of cameras may be used in combination.

(6) For the state detection of the target object 4, a detection time may be set, and whether the target object 4 is normal or abnormal may be detected from the presence or absence of behavior within the detection time.

(7) Regarding the blocking of the distance image or the volume image, elevation information indicating the height distance of the pixel gi from the distance image may be defined, and the blocking may be performed for each pixel group associated with the height of the pixel included in the image information indicated by the elevation information.

(8) In the above embodiment, the processing device 12 may compare the virtual area or the virtual volume between the frames and detect the state variation of the target object 4 from the difference between previous and following.

According to an aspect of the embodiments or examples described above, a detection system, a detection method, a program, or a detection module is as follows.

According to an aspect of a detection system of the present disclosure, there is provided a detection system including: an imaging unit configured to acquire a distance image indicating a distance to a target object in time sequence; and a processing unit configured to divide pixels included in the distance image into blocks according to a distance relationship, and detect a state of the target object by comparing ratios of pixels included in the respective blocks.

In this detection system, the processing unit may compare pixels included in previous and following distance images, and detect a state variation of the target object from a difference between the pixels.

In this detection system, the processing unit may compare the pixels between frames of the distance image

In this detection system, the processing unit may calculate previous and following virtual areas and/or previous and following virtual volumes of the target object by using the pixels included in the blocks, and detect a state variation of the target object by comparing the previous and following virtual areas or comparing the previous and following virtual volumes.

In this detection system, the processing unit may compare previous and following coordinates of pixels included in a plurality of the distance images, virtual area images, or virtual volume images, and detect a state variation of the target object from a difference between the previous and following coordinates.

In this detection system, the coordinates may include any of a singular point, a centroid point, and a vertex included in the distance images, the virtual area images, or the virtual volume images.

The detection system may further include an information presentation unit configured to present one or more of the distance image, a virtual area, a virtual volume, and state information indicating the state of the target object.

According to an aspect of the detection method of the present disclosure, there is provided a detection method including: acquiring, by an imaging unit, a distance image in time sequence, the distance image indicating a distance to a target object; detecting, by the processing unit, a state of the target object by dividing pixels included in the distance image into blocks according to a distance relationship and comparing a ratio of pixels included in the respective blocks; and calculating a virtual area or a virtual volume for each block for at least each state of the target object by using the pixels included in the respective blocks.

The detection method may further include comparing previous and following distance images and detecting a state variation of the target object from a difference between the distance images, by the processing unit.

The detection method may further include calculating previous and following virtual areas and/or previous and following virtual volumes of the target object by using the pixels included in the blocks and detecting a state variation of the target object by comparing the previous and following virtual areas between frames or comparing the previous and following virtual volumes between frames, by the processing unit.

According to an aspect of a program of the present disclosure, there is provided a program for causing a computer to execute: acquiring a distance image indicating a distance to a target object in time sequence; and dividing pixels included in the distance image into blocks according to a distance relationship and detecting a state of the target object by comparing ratios of pixels included in the respective blocks.

The program may further cause the computer to execute: calculating a virtual area or a virtual volume for each block for at least each state of the target object by using the pixels included in the respective blocks.

The program may further cause the computer to execute comparing previous and following distance images and detecting a state variation of the target object from a difference between the distance images.

According to an aspect of a detection module of the present disclosure, there is provided a detection module including: an imaging unit configured to acquire a distance image indicating a distance to a target object in time sequence; and a processing unit configured to divide pixels included in the distance image into blocks according to a distance relationship, and detect a state of the target object by comparing ratios of pixels included in the respective blocks.

In the detection module, the processing unit may compare previous and following distance images, and detect a state variation of the target object from a difference between the distance images.

In the detection module, the processing unit may calculate previous and following virtual areas and/or previous and following virtual volumes of the target object by using the pixels included in the blocks and detect a state variation of the target object by comparing the previous and following virtual areas or comparing the previous and following virtual volumes between frames.

According to aspects of the embodiments or the examples, any of the following effects can be obtained.

(1) The pixels included in the distance image are divided into two or more blocks according to the distance relationship, the virtual area or the virtual volume is calculated using the pixels of each block, and the ratio of each virtual area or each virtual volume is compared, so that the state of the target object can be easily detected with high accuracy.

(2) Since the state of the target object is detected by the ratio of the virtual area or the virtual volume for each block, in a case where the target object is, for example, a human, information other than the state of the target object such as attribute information such as gender can be omitted, the information used for the detection processing can be reduced, the load of the information processing can be reduced, and the processing can be speeded up.

(3) The state of the target object can be detected by comparing frames indicating the virtual areas or virtual volumes divided into blocks from the distance image.

As described above, the most preferred embodiment and the like of the present disclosure have been described. The technology of the present disclosure is not limited to the above description. Various modifications and changes can be made by those skilled in the art based on the gist of the invention described in the claims or disclosed in the specification. It goes without saying that such modifications and changes are included in the scope of the present invention.

According to the state detection system, method, program, and detection module of the present disclosure, the state of a target object such as a human can be easily detected with high accuracy using a distance image obtained from the target object.

What is claimed is:

1. A detection system comprising:
an imaging unit configured to acquire a distance image indicating a distance to a target object; and
a processing unit configured to divide pixels included in the distance image into blocks according to a distance relationship, and detect a state of the target object by comparing ratios of pixels included in the respective blocks.

2. The detection system according to claim 1, wherein the processing unit compares pixels included in previous and following distance images, and detects a state variation of the target object from a difference between the pixels.

3. The detection system according to claim 1, wherein the processing unit compares the pixels between frames of the distance image.

4. The detection system according to claim 1, wherein the processing unit calculates previous and following virtual areas and/or previous and following virtual volumes of the target object by using the pixels included in the blocks, and detects a state variation of the target object by comparing the previous and following virtual areas or comparing the previous and following virtual volumes.

5. The detection system according to claim 1, wherein the processing unit compares previous and following coordinates of pixels included in a plurality of the distance images, virtual area images, or virtual volume images, and detects a state variation of the target object from a difference between the previous and following coordinates.

6. The detection system according to claim 5, wherein the coordinates include any of a singular point, a centroid point, and a vertex included in the distance images, the virtual area images, or the virtual volume images.

7. The detection system according to claim 1, further comprising an information presentation unit configured to present one or more of the distance image, a virtual area, a virtual volume, and state information indicating the state of the target object.

8. A detection method comprising:
acquiring, by an imaging unit, a distance image in time sequence, the distance image indicating a distance to a target object;
detecting, by the processing unit, a state of the target object by dividing pixels included in the distance image into blocks according to a distance relationship and comparing a ratio of pixels included in the respective blocks; and
calculating a virtual area or a virtual volume for each block for at least each state of the target object by using the pixels included in the respective blocks.

9. The detection method according to claim 8, further comprising comparing previous and following distance images and detecting a state variation of the target object from a difference between the distance images, by the processing unit.

10. The detection method according to claim 8, further comprising calculating previous and following virtual areas and/or previous and following virtual volumes of the target object by using the pixels included in the blocks and detecting a state variation of the target object by comparing the previous and following virtual areas between frames or comparing the previous and following virtual volumes between frames, by the processing unit.

11. A non-transitory computer readable medium storing a program for causing a computer to execute:
acquiring a distance image indicating a distance to a target object in time sequence; and
dividing pixels included in the distance image into blocks according to a distance relationship and detecting a state of the target object by comparing ratios of pixels included in the respective blocks.

12. The non-transitory computer readable medium according to claim 11, the program further causing the computer to execute:
calculating a virtual area or a virtual volume for each block for at least each state of the target object by using the pixels included in the respective blocks.

13. The non-transitory computer readable medium according to claim 11, the program further causing the computer to execute comparing previous and following distance images and detecting a state variation of the target object from a difference between the distance images.

14. A detection module comprising:
an imaging unit configured to acquire a distance image indicating a distance to a target object in time sequence; and
a processing unit configured to divide pixels included in the distance image into blocks according to a distance relationship, and detect a state of the target object by comparing ratios of pixels included in the respective blocks.

15. The detection module according to claim 14, wherein the processing unit compares previous and following distance images, and detects a state variation of the target object from a difference between the distance images.

16. The detection module according to claim 14, wherein the processing unit calculates previous and following virtual areas and/or previous and following virtual volumes of the target object by using the pixels included in the blocks, and detects a state variation of the target object by comparing the previous and following virtual areas or comparing the previous and following virtual volumes between frames.
